(19) United States
(12) Patent Application Publication
(10) Pub. No.: US 2017/0369148 A1
(43) Pub. Date: Dec. 28, 2017

(54) METHOD OF MAKING PAD-UPS FOR COMPOSITE STRUCTURES AND COMPOSITE STRUCTURES INCLUDING PAD-UPS

(71) Applicant: BOMBARDIER INC., Dorval (CA)

(72) Inventors: Marc-Arthur DE GROSBOIS, Vercheres (CA); Jean-Philippe LACHANCE, L'Ile Bizard (CA)

(73) Assignees: BOMBARDIER INC., Dorval, QC (CA); BOMBARDIER INC., Dorval, QC (CA)

(21) Appl. No.: 15/533,809

(22) PCT Filed: Dec. 4, 2015
(86) PCT No.: PCT/IB2015/059367

§ 371 Date: Jun. 7, 2017

Related U.S. Application Data
(60) Provisional application No. 62/090,976, filed on Dec. 12, 2014.

(51) Int. Cl. B64C 3/18; B29D 24/00; B29D 99/00; B29C 70/50; B29C 70/38; B29C 70/24; B64C 1/06; B29C 70/08; B29L 31/30

(52) U.S. Cl. CPC B64C 3/185; B64C 1/068; B29D 24/008; B29D 99/0003; B29C 70/08; B29C 70/50; B29C 70/382; B29C 70/24; B29L 2031/3085

(57) ABSTRACT

A composite component (16) for a vehicle (10) includes a laminate (18) made from a composite material, a first pad-up area (22) applied to the laminate (18), where the first pad-up area (22) includes a plurality of first tows laid next to one another in a side-by-side arrangement and where the first pad-up area (22) defines a first fiber orientation, and a second pad-up area (24), where the second pad-up area (24) includes a plurality of second tows laid next to one another in a side-by-side arrangement and where the second pad-up area (24) defines a second fiber orientation that differs by a predetermined angle from the first fiber orientation. The first pad-up area (22) and the second pad-up area (22) intersect at an intersecting area and together form a first pad-up ply on the laminate (18).

### CROSS-REFERENCE TO RELATED APPLICATION(S)

The present application claims priority to U.S. provisional patent application No. 62/090,976 filed on Dec. 12, 2014, the entire contents of which are hereby incorporated by reference.

### FIELD OF THE INVENTION

The present invention concerns a method for constructing one or more pad-ups for composite structures and composite structures including one or more pad-ups. In particular, the present invention concerns a method for constructing pad-ups for composite structures that incorporate prepreg composite materials. More specifically, the present invention is contemplated to be employed by an automated fiber placement (“AFP”) system for laying prepreg materials to provide composite structures including one or more pad-ups.

### DESCRIPTION OF THE BACKGROUND AND RELATED ART

Pre-impregnated composite fabric materials (i.e., prepreg materials) are often used in the manufacturing of composite components, such as aircraft components, among other possibilities. Prior to being cured into a final composite component, the prepreg material comprises a fabric layer onto which has been applied resin, such that the resin at least partially impregnates the fabric layer.

To form a composite structure, it is customary to stack multiple layers, or plies, of composite fabric materials on top of one another. Typically, this is done by hand (i.e., hand lay-up), which is time consuming and, therefore, expensive.

With respect to certain aircraft components, it is customary to include thickened areas (referred to as “pad-ups”) at locations on the aircraft component where structural elements are to be attached. Conventionally, these pad-ups also are created using hand lay-up techniques.

In view of the foregoing, a need has developed whereby aircraft components, including those incorporating pad-ups, may be manufactured via automated or semi-automated techniques including, but not limited to AFP and/or automated tape laying (“ATL”) machines.

### SUMMARY OF THE INVENTION

The present invention addresses one or more of the deficiencies noted with respect to the prior art.

The present invention provides a composite component for a vehicle. The composite component includes a laminate made from a composite material, a first pad-up area applied to the laminate, where the first pad-up area includes a plurality of first tows laid next to one another in a side-by-side arrangement and where the first pad-up area defines a first fiber orientation, and a second pad-up area, where the second pad-up area includes a plurality of second tows laid next to one another in a side-by-side arrangement and where the second pad-up area defines a second fiber orientation that differs by a predetermined angle from the first fiber orientation. The first pad-up area and the second pad-up area intersect at an intersecting area and together form a first pad-up ply on the laminate.

In one contemplated embodiment, the first fiber orientation is along a first load path of the composite component.

In another contemplated embodiment, the second fiber orientation is along a second load path of the composite component.

It is contemplated that the composite component may be constructed such that at least a portion of the first pad-up area and the second pad-up area lie in the same layer.

Still further, the composite component may be constructed so that at least one interleaf layer is positioned between the first pad-up area and the second pad-up area.

In another contemplated embodiment, the first pad-up area and the second pad-up area may overlap at the intersecting area.

It is also contemplated that the first pad-up area may abut the second pad-up area at the intersecting area.

In one contemplated embodiment, the predetermined angle is less than or equal to about 90°.

It is contemplated that the first pad-up ply may be applied to the laminate via an automated fiber placement machine.

Other embodiments contemplate that the first pad-up area may be applied to the laminate via an automated fiber placement machine by steering the plurality of first tows.

Still further, the second pad-up area may be applied to the laminate via an automated fiber placement machine by steering the plurality of second tows.

Where used, automated fiber placement machine may lay a plurality of first pad-up areas on the component prior to changing direction for laying a plurality of second pad-up areas on the component.

For one or more embodiments of the present invention, a plurality of first pad-up areas and a plurality of second pad-up areas on the component provide a lattice of pad-up areas.

With respect to one or more contemplated embodiments, the laminate, the first pad-up area, and the second pad-up area are made from carbon fiber materials preimpregnated with resin.

The present invention also provides a composite component for a vehicle that includes a lattice pattern of pad-up areas and interstitial areas positioned between the pad-up areas. The lattice pattern of pad-up areas includes at least a first pad-up area and at least a second pad-up area that intersects with the first pad-up area. The first pad-up area has a first fiber direction that extends along a first length of the first pad-up area and the second pad-up area has a second fiber direction that extends along a second length of the second pad-up area. The first pad-up area and the second pad-up area intersect at a predetermined angle.

In connection with this embodiment, it is contemplated that the pad-up area and the second pad-up area overlap at an intersecting area.

It is also contemplated for the composite component that the first pad-up area abuts the second pad-up area at an intersecting area.

The composite component may include at least one interleaf layer positioned between the first pad-up area and the second pad-up area.

With respect to the composite component, at least a portion of the first pad-up area and the second pad-up area may lie in the same layer.

Further aspects of the present invention will be made apparent from the paragraphs that follow.

### BRIEF DESCRIPTION OF THE DRAWING(S)

The present invention will now be described in connection with the drawings appended hereto, in which:

FIG. 1 is a perspective illustration of an aircraft showing a portion of the tail section of the aircraft's fuselage of the type that may be constructed from one or more of the components manufactured according to the present invention;

FIG. 2 is a perspective illustration of the portion of the tail section of the aircraft illustrated in FIG. 1, providing enhanced details to facilitate the discussion of selected elements of the present invention;

FIG. 3 is a perspective illustration of a component, contemplated as a part of a fuselage, showing pad-up areas that support stringers and structural elements attached to or incorporated into the aircraft component;

FIG. 4 is a perspective illustration of the aircraft component shown in FIG. 3 with the stringers and structural elements removed, thereby highlighting the location, size and shapes of the various pad-up areas;

FIG. 5 is a perspective illustration of an aircraft component, showing an exemplary, non-limiting application of a stack of plies for a pad-up area, such as may be applied by hand (i.e., a manual construction);

FIG. 6 is a perspective illustration of a first embodiment of the creation of one ply for a pad-up for an aircraft structure according to the present invention;

FIG. 7 is a graphical, top plan view of a second embodiment of one ply for a pad-up for an aircraft structure according to the present invention;

FIG. 8 is a graphical, top plan view of a third embodiment of one ply for a pad-up for an aircraft structure according to the present invention;

FIG. 9 is an exploded, perspective illustration of multiple plies layered on top of one another to form a pad-up for an aircraft structure according to the present invention;

FIG. 10 is a graphical, top plan view of a first ply of composite material employed in several of the layers illustrated in FIG. 9;

FIG. 11 is a graphical, top plan view of a second ply of composite material employed in several of the layers illustrated in FIG. 9;

FIG. 12 is a graphical, top plan view of a third ply of composite material employed in one of the layers illustrated in FIG. 9;

FIG. 13 is a graphical, top plan view of a fourth ply of composite material employed in one of the layers illustrated in FIG. 9;

FIG. 14 is a perspective illustration of a portion of an aircraft fuselage of the type that may be employed on the tail section of the aircraft illustrated in FIG. 1, showing the locations of selected pad-up areas to highlight aspects of the present invention;

FIG. 15 is a view of the interior surface of the portion of the aircraft fuselage illustrated in FIG. 14, showing the same, selected pad-up areas for illustration;

FIG. 16 is an enlarged illustration showing a portion of the pad-up areas for the portion of the fuselage element illustrated in FIGS. 14 and 15;

FIG. 17 is a perspective illustration of the interior surface of the fuselage portion illustrated in FIG. 14, showing the curvature of the interior surface;

FIG. 18 is a top view of another embodiment of an aircraft structure according to the present invention; and

FIG. 19 is a perspective view of the embodiment illustrated in FIG. 18.

### DETAILED DESCRIPTION OF EMBODIMENT(S) OF THE INVENTION

The present invention will now be described in connection with one or more embodiments thereof. The discussion of the embodiments is not intended to be limiting of the present invention. To the contrary, any discussion of embodiments is intended to exemplify the breadth and scope of the present invention. As should be apparent to those skilled in the art, variations and equivalents of the embodiment(s) described herein may be employed without departing from the scope of the present invention. Those variations and equivalents are intended to be encompassed by the scope of the present patent application.

The present invention will now be discussed in the context of a composite prepreg material for manufacture of components of a vehicle, such as a jet aircraft for example. A composite prepreg material is defined, generally, as a material which may be woven, non-woven, provided in sheets, and/or provided in tapes or tows. The material typically includes carbon fiber, but other materials (including, but not limited to, aramid fibers, nylon, glass, and fiberglass) may be employed. Additionally, while described in connection with the use of prepreg materials, the present invention may be employed with non-prepreg materials (or other substitutable materials).

Without limiting the scope of the present invention, it is contemplated that the construction of a composite fiber structure will include, at least in part, the assistance of an AFP machine or an ATL machine. In the context of the discussion that follows, the terminology of an AFP machine is used, as this encompasses the contemplated embodiment of the present invention. As noted, however, reference to an AFP machine is not intended to be limiting of the present invention.

In one embodiment, an AFP machine may create a composite structure for an aircraft by laying a plurality of carbon fiber tows in a side-by-side manner along a mold. The plurality of narrow tows may be laid simultaneously in order to provide a band having a total width greater than that of the individual tows. In a non-limiting embodiment, a band may be formed of sixteen (16) tows that are laid in a side-by-side manner to create the band having a width that is the sum of the sixteen (16) tows. The tows within the band may all be laid together, or alternatively, the AFP machine may lay one or more of the tows within the band individually. As few as one (1) tow may be laid at any given time and as many as sixteen (16) tows may be laid simultaneously, as required or as desired. The AFP machine is contemplated to have the capacity to stop laying the tows, to change its directional orientation, and begin laying the tows again. The operation and construction of an AFP machine should be apparent to those skilled in the art. Therefore, further details about the AFP machine are omitted, unless needed to discuss one or more of the details of the present invention that follow.

Individual tows are contemplated to be made from a non-woven carbon fiber material that is pre-impregnated with a suitable resin. As such, the tows may be prepregs as defined herein. In the contemplated embodiment, the tows are contemplated to include a plurality of carbon fibers that are oriented in the same direction or substantially the same direction. Specifically, the tows are contemplated to define a fiber direction that extends along the direction of the application of the tows to the laminate. As such, the fiber directions or orientations extend along the lengths of the pad-up areas, as defined herein. It is to be understood that as the tows are steered along the deposition surface, the fiber orientation may vary in relation to the laminate, but will still extend in a direction along the length of the pad-up area.

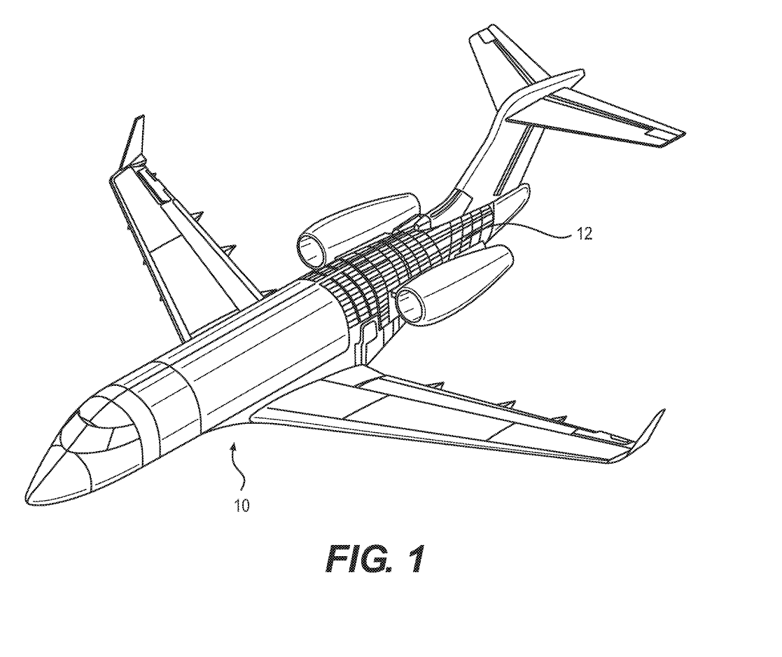

With reference to FIG. 1, the present invention is contemplated to be employed in the construction of aircraft 10, such as jet aircraft 10. While the invention is discussed in this context, the present invention is not intended to be limited solely to jet aircraft 10. The present invention also is applicable to any other type of aircraft, as should be apparent to those skilled in the art. In addition, while discussed in the context of jet aircraft 10, the present invention may apply to vehicles other than aircraft, such as cars, buses, and trains, as well as to non-transportation components, such as wind turbines.

In the following description, the same numerical references are intended to refer to similar elements. The re-use of reference numerals for different embodiments of the present invention is intended to simplify the discussion of the present invention. It should not be inferred, therefore, that the re-use of reference numbers is intended to convey that the associated structure or element is identical to any other described embodiment.

Although the preferred embodiments of the present invention as illustrated in the accompanying drawings comprise various components, and although the preferred embodiments of the system and corresponding parts of the present invention as shown consist of certain geometrical configurations as explained and illustrated herein, not all of these components and geometries are essential to the invention and, thus, should not be taken in their restrictive sense, i.e., should not be taken as to limit the scope of the present invention.

It is to be understood, as should be apparent to a person skilled in the art, that other suitable components and cooperations therebetween, as well as other suitable geometrical configurations, may be used for the present invention, as will be briefly explained herein and as may be easily inferred therefrom by a person skilled in the art, without departing from the scope of the invention.

Additionally, it should be appreciated that positional descriptions such as “right,” “left,” “top,” “bottom,” and the like are, unless otherwise indicated, to be taken in the context of the figures and should not be considered to be limiting of the present invention.

It will be appreciated that the present invention may be practiced without all of the specific details which are set forth herein below in order to provide a thorough understanding of the invention.

FIG. 1 is perspective illustration of a jet aircraft 10. The jet aircraft 10 is contemplated to be constructed at least partially from composite materials, such as carbon fiber composite materials. In the illustration provided in FIG. 1, the tail section 12 of the jet aircraft 10 is shown in a skeletonized manner. The skeletonized tail section 12 is contemplated to indicate that at least this section of the jet aircraft 10 may be made from carbon fiber composite materials. As should be apparent, any other portion of the jet aircraft 10, in addition to the tail section 12, may be constructed from a composite material without departing from the scope of the present invention.

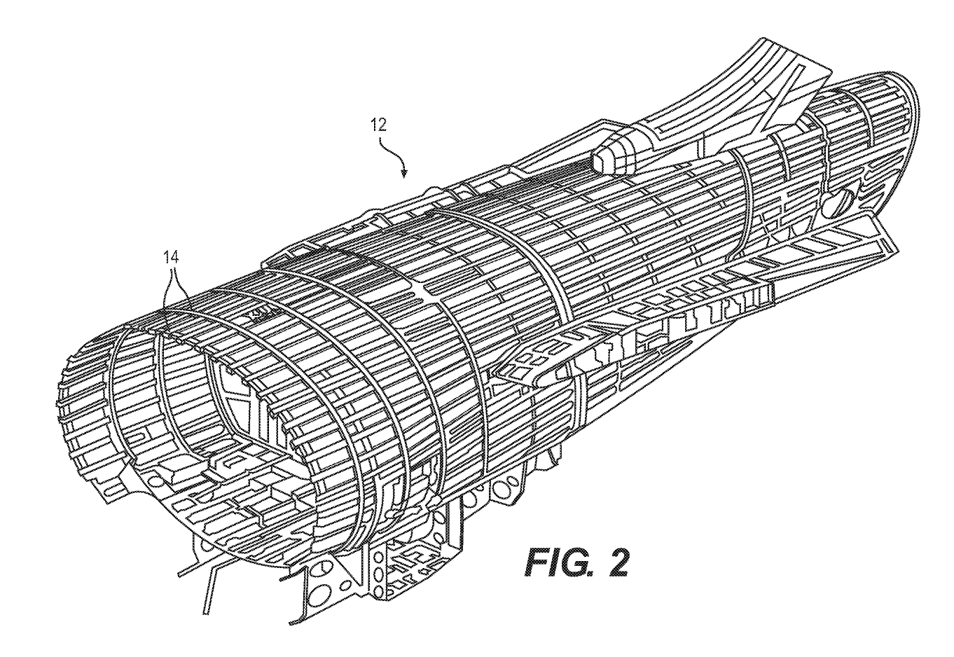

FIG. 2 provides an enlarged, perspective view of the tail section 12 of the jet aircraft 10 illustrated in FIG. 1. The illustration of the tail section 12 provides details about selected structural elements 14 necessary for the construction of the jet aircraft 10.

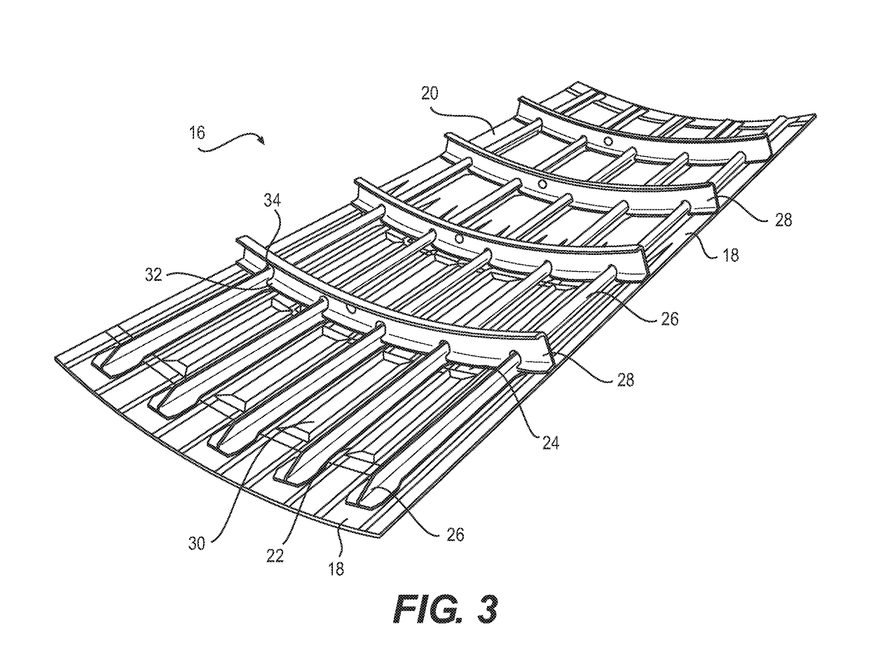

FIG. 3 is a perspective illustration of an aircraft component 16. The aircraft component 16 shown in FIG. 3 may form an exterior surface of the fuselage for the jet aircraft 10. Alternatively, the aircraft component 16 may be part of a fairing or other component forming at least a part of the external structure of the jet aircraft 10. Still further, the aircraft component 16 may be part of an internal structure within the jet aircraft 10. While the present invention will be discussed in connection with the manufacture primarily of external, structural components (e.g., skin elements) of a jet aircraft 10, the present invention should not be understood to be limited solely thereto.

As illustrated in FIG. 3, the aircraft component 16 includes a laminate, such as curved element 18, which may form a portion of the fuselage of the jet aircraft 10. While the curved element 18 is shown with a curved structure, it is noted that the curved element 18 may be planar in an alternative contemplated embodiment. Still further, it is contemplated that the curved element 18 may have any contour suitable for the construction of the aircraft in which the curved element 18 is incorporated. For example, the curved element 18 may be a single curvature element or a double curvature element.

The curved element 18, also referred to herein as “the laminate,” may be any material onto which the pad-up areas 20 are formed. In one embodiment, it is contemplated that the laminate or curved element 18 may be as thin as a single ply of carbon fiber material. In other embodiments, the laminate or curved element may comprise a plurality of plies arranged to form a stack of plies. Still further constructions for the laminate or curved element 18 may be used without departing from the scope of the present invention.

In the illustrated embodiment, the laminate or curved element 18 includes a lattice pattern of pad-up areas 20 that are collectively formed on an interior surface thereof, with interstitial areas 30 positioned therebetween. In the non-limiting embodiment shown in FIG. 3, the lattice pattern of the pad-up areas 20 takes the appearance, at least in part, of perpendicularly intersecting lines on a piece of graph paper. In the illustrated embodiment, the lattice pattern of pad-up areas 20 includes first pad-up areas 22 that extend longitudinally along a length of the laminate or curved element 18 and second pad-up areas 24 that extend laterally across a width of the laminate or curved element 18 and intersect the first pad-up areas 22.

As will be made apparent in the discussion that follows, the longitudinal axis of the laminate or curved element 18 is defined in relation to the length of the laminate or curved element 18. Similarly, the lateral axis of the laminate or curved element 18, while being described in terms of the width of the laminate or curved element 18, is intended to refer to an orientation that is orthogonal to the longitudinal axis. It is further noted that the longitudinal and lateral orientations are merely provided to clarify spatial relationships between the elements described. The terms “longitudinal” and “lateral,” therefore, should not be understood as having any relation or correspondence to the longitudinal and lateral axes of the jet aircraft 10 illustrated in FIG. 1.

Two sets of structural elements 26, 28 are attached to the pad-up areas 22, 24, respectively. Since the structural elements 26, 28 are disposed on the pad-up areas 22, 24, the structural elements 26, 28 are arranged in the same lattice pattern established by the pad-up areas 22, 24. First structural elements 26, sometimes referred to as stringers, extend longitudinally along a length of the laminate or curved element 18 (i.e., along a first direction). Second structural elements 28, sometimes referred to as C-frames, extend laterally across a width of the laminate or curved element 18, in a direction cross-wise to the first structural elements 26 (i.e., in a second direction). As should be apparent from the illustrated embodiment, in this non-limiting embodiment, the first structural elements 26 are arranged orthogonally (or substantially orthogonally) to the second structural elements 28.

Concerning the first and second structural elements 26, 28, it is contemplated that the two structural elements 26, 28 may have any construction that is required or desired to provide additional strength to the location on the laminate or curved element 18 where the structural element 26, 28 are placed. The structural elements 26, 28 may be constructed as stringers, including, but not limited to, I-beams, C-beams, T-beams, L-beams, Z-beams, delta-beams, and/or omega beams and/or any other type of structural element 26, 28 that might be employed in the construction of the structure of a jet aircraft 10 and its associated components. Without limitation, the structural elements 26, 28 may extend longitudinally, laterally, orbitally, or at a predetermined angle with respect to one or more other structural elements 26, 28. In other words, the present invention is not contemplated to be limited to any particular construction or orientation of the structural elements 26, 28.

As discussed more fully herein, it is contemplated that the structural elements 26, 28 will be affixed to the pad-up areas 22, 24. Affixation is intended to encompass any number of different fasteners to connect the structural elements 26, 28 to the pad-up areas 22, 24. In one contemplated embodiment, the structural elements 26, 28 are co-cured and/or co-bonded together with the pad-up areas 22, 24 and are, therefore, an integral part of the laminate or curved element 18. In a second contemplated embodiment, the structural elements 26, 28 are cured before being attached to the pad-up areas 22, 24 via a suitable adhesive. In a third contemplated embodiment, the structural elements 26, 28 are cured before being attached to the pad-up areas 22, 24 via a suitable fastener, such as a rivet. In addition, one or more of the structural elements 26, 28 may be affixed to the pad-up areas 22, 24 via a suitable fastener, such as a rivet, in addition to being co-cured and/or co-bonded therewith. Finally, it is contemplated that one or more of the structural elements 26, 28 may be made from a metal alloy such as an alloy of aluminum, iron, titanium, magnesium, beryllium, or the like, and affixed to the pad-up areas 22, 24 via a suitable fastener, such as a rivet. As noted, the manner in which the structural elements 26, 28 are affixed to the pad-up areas 22, 24 is not considered to be limiting of the present invention.

In the embodiment of the aircraft component 16 illustrated in FIG. 3, the pad-up areas 22, 24 and the structural elements 26, 28 are contemplated to be in register with one another. Specifically, the structural elements 26, 28 are centered on and attached to respective ones of the pad-up areas 22, 24. The structural elements 26, 28, however, do not need to be centered exactly on the pad-up areas 22, 24 to practice the present invention. Instead, the structural elements 26, 28 may be offset from the centerlines of respective ones of the pad-up areas 22, 24.

The pad-up areas 22, 24 establish areas on the laminate or curved element 18 that are thicker than the interstitial areas 30 therebetween. As a result, the pad-up areas 22, 24 provide locations with a greater structural strength than the interstitial areas 30. With this construction, the pad-up areas 22, 24 provide areas with heightened strength to support the fasteners (mechanical, adhesive, or otherwise) that attach the structural elements 26, 28 thereon. In particular, the pad-up areas 22, 24 are made thick enough so that the structural elements 26, 28 may be fastened to the laminate or curved element 18 via suitable fasteners. As noted above, fasteners include, but are not limited to rivets, nuts and bolts, screws, adhesives, welds, etc. With the interstitial areas 30 being less thick than the pad-up areas 22, 24, the aircraft component 16 may be lightened in weight to contribute to weight savings within the jet aircraft 10 as a whole, while maintaining a required thickness at the regions where fasteners are required and/or desired.

Furthermore, it is noted that the pad-up areas 22, 24 and the structural elements 26, 28 need not be arranged perpendicularly to one another. To the contrary, the pad-up areas 22, 24, and the structural elements 26, 28 may be disposed at any predetermined angle with respect to one another without departing from the scope of the present invention, as will be described in more detail below.

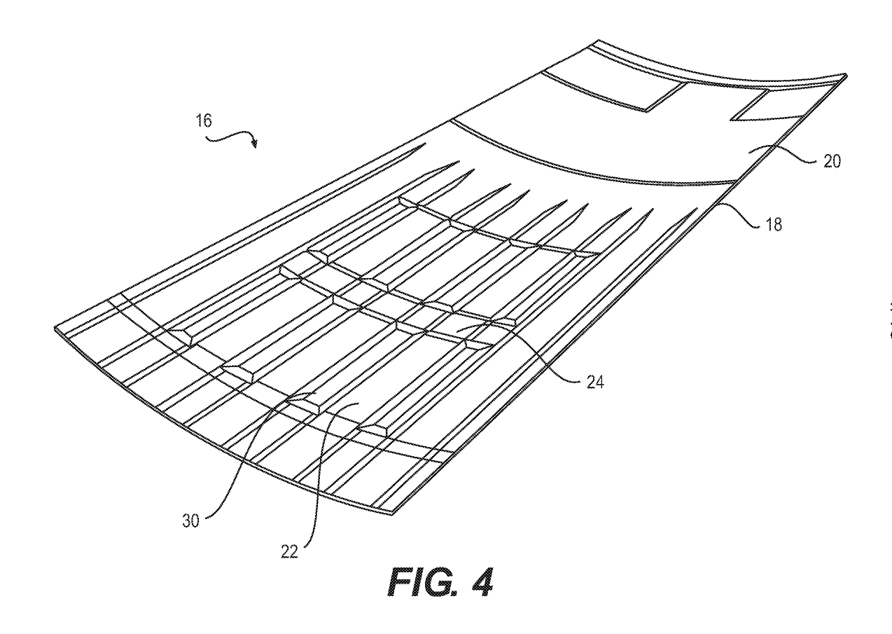

FIG. 4 is a perspective illustration of the laminate or curved element 18 shown in FIG. 3. In this illustration, to facilitate an understanding of the locations of the pad-up areas 22, 24, the structural elements 26, 28 are omitted.

In the embodiment illustrated in FIGS. 3 and 4, the pad-up areas 22, 24 are separated equidistantly from one another. Accordingly, the structural elements 26, 28 also are separated from one another equidistantly. The present invention, however, does not require equidistant spacing between adjacent pad-up areas 22, 24 or between adjacent structural elements 26, 28. To the contrary, the spacing between adjacent pad-up areas 22, 24 and adjacent structural elements 26, 28 may vary without departing from the scope of the present invention.

In another contemplated embodiment, a greater number of pad-up areas 20 may be disposed on the laminate or curved element 18. If so, the additional pad-up areas 20 may be angled with respect to the illustrated pad-up areas 22, 24. For example, the additional pad-up areas 20 may be angled at 45° with respect to the first and second pad-up areas 22, 24. If additional pad-up areas 20 are disposed on the laminate or curved element 18, it is contemplated that additional structural elements 26, 28 will be disposed on the additional pad-up areas 20, consistent with the placement of the structural elements 26, 28 on the pad-up areas 22, 24.

With continued reference to FIG. 3, it is noted that the second structural elements 28 may include joggles 32 and cut outs 34 so that the structural elements 26, 28 may be placed onto the laminate or curved element 18 without interfering with one another. In addition, the joggles 32 and cut outs 34 permit the placement of the structural elements 26, 28 onto the laminate or curved element 18 so that the elements are within prescribed engineering tolerances.

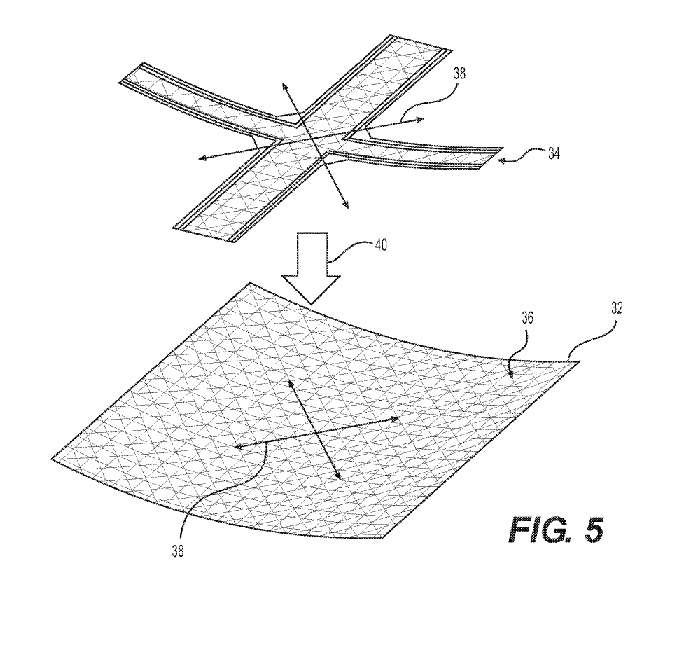

FIG. 5 is a perspective illustration of a laminate or a curved element 32, providing one example of the application of a stack 34 of composite plies thereto. While not illustrated, it is noted that the stack 34 of plies may include interleafed plies, as discussed further herein. A pad-up area 20 is created after the stack 34 of plies of composite material are affixed, with or without interleafed layers, to the interior surface 36 of the laminate or curved element 32, where the stack 34 is applied by hand (or manually) to the laminate or curved element 32. In this embodiment, the stack 34 of composite fiber plies takes the form of a “+.” The stack 34, therefore, establishes a pad-up area 20 in both the longitudinal and the lateral directions of the laminate or curved element 32.

In FIG. 5, orthogonal arrows 38 are provided with reference to the stack 34 and the laminate or curved element 32 to facilitate understanding of the orientation of the stack 34 onto the laminate or curved element 32. In addition, an arrow 40 is provided in the illustration to show the direction of application of the stack 34 of composite plies to the laminate or curved element 32 (i.e., the application direction 40). It is noted that orthogonal arrows 38 are provided in several of the figures to permit orientation of the various figures with respect to one another and, thereby, to facilitate an understanding of the scope and breadth of the present invention.

As may be apparent to those skilled in the art of constructing composite structures, it is common to apply multiple single plies, either individually or in a stack 34, to create a pad-up area 20. As also should be understood by those skilled in the art, individual plies each have a particular fiber orientation and the strength of the resulting composite material depends upon the fiber orientations within the single plies. To create a composite structure with good strength in multiple directions, therefore, single plies are often deposited onto the laminate or curved element 32 such that the fiber directions/orientations change between successive single plies.

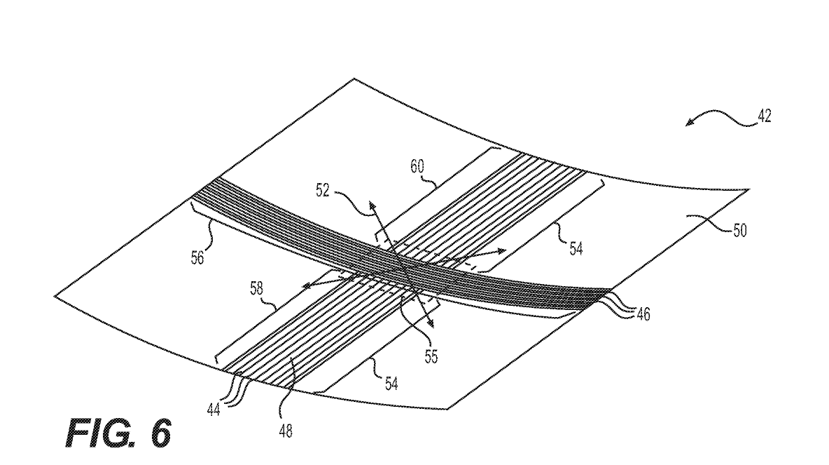

As will be explained in more detail with respect to FIGS. 6 through 8, in accordance with the present invention, the pad-up areas of a composite component are formed from a plurality of first pad-up areas that intersect a plurality of second pad-up areas at intersecting areas. As used herein, the term “intersect” may mean that the first pad-up areas abut the second pad-up areas at the intersecting areas or that the first pad-up areas overlap the second pad-up areas at the intersecting areas, partially or wholly. Each of the first pad-up areas and second pad-up areas may be laid by the AFP machine such that the fiber orientation of the given pad-up area extends along the length of that pad-up area. In this manner, a single ply of a pad-up area is formed from a first pad-up area and a second pad-up area that have fiber orientations that extend in different directions. As will be explained in more detail below, the first pad-up area and the second pad-up area that form a single ply of a pad-up area may have interleaf layers of the composite component positioned therebetween.

Interleaf layers include composite materials in one contemplated embodiment. However, in other contemplated embodiments, the interleaf layers may include one or more layers of carbon fibers, strength materials, metal layers, metal mesh materials, copper mesh materials, galvanic corrosion protection layers, lighting strike protection layers, etc. In other words, the interleaf layers may be made from a wide variety of materials without departing from the scope of the present invention. Interleaf layers may be coextensive, partially or wholly, with the laminate or curved element 32. In other words, the interleaf layers may cover only a part of the laminate or curved surface 32. Alternatively, some interleaf layers may cover the entire surface of the laminate or curved surface 32.

FIG. 6 is a perspective illustration of a first embodiment of an aircraft component 42 according to the present invention, showing a pad-up area 48 that comprises the deposition of a plurality of first tows 44 and a plurality of second tows 46 onto the laminate or curved element 50. The plurality of first tows 44 are oriented in a first direction (which in the embodiment shown is in the longitudinal direction of the laminate or curved element 50 and the plurality of second tows 46 are oriented along a second direction (which in the embodiment shown is in the lateral direction) of the laminate or curved element 50. In this first embodiment, it is contemplated that the pad-up area 48 is deposited using an AFP machine as discussed above. For reference, a pair of orthogonal arrows 52 are included in FIG. 6.

As also illustrated in FIG. 6, the plurality of first tows 44 are laid, side-by side, to form a first pad-up area 54 and the plurality of second tows 46 are laid, side-by-side, onto the laminate or curved element 50 to form the second pad-up area 56. When both the first plurality of tows 44 and the second plurality of tows 46 are laid onto the laminate or curved surface 50, they establish a single ply of the pad-up area 48. However, as described above, it is to be understood that there may be interleaf layers positioned between the first pad-up area 54 and the second pad-up area 56, such that the two areas of the single pad-up ply do not lie in the same layer.

For the pad-up area 48 illustrated in FIG. 6, it is noted that the first pad-up area 54 intersects with the second pad-up area 56 in an intersecting area 55. As a result, the first pad-up area 54 is divisible into a first region 58 and a second region 60. The first region 58 lies on one side of the second pad-up area 56. The second region 60 lies on the other side of the second pad-up area 56 opposite to the first region 58. Therefore, although the first region 58 and the second region 60 intersect the second pad-up area 56, neither the first region 58 nor the second region 60 overlaps the second pad-up area 56. As a result, the pad-up area 48 has a consistent thickness throughout, such that both the first plurality of tows 44 of the first pad-up area 54 and the second plurality of tows 46 of the second pad-up area 56 form parts the same pad-up ply. Alternatively, and as indicated above, there could be interleaf layers between the first pad-up area 54 and the second pad-up area 56. The interleaf layers may cover a portion of the laminate or curved surface 50 or may cover the entirety of the laminate or curved surface 50.

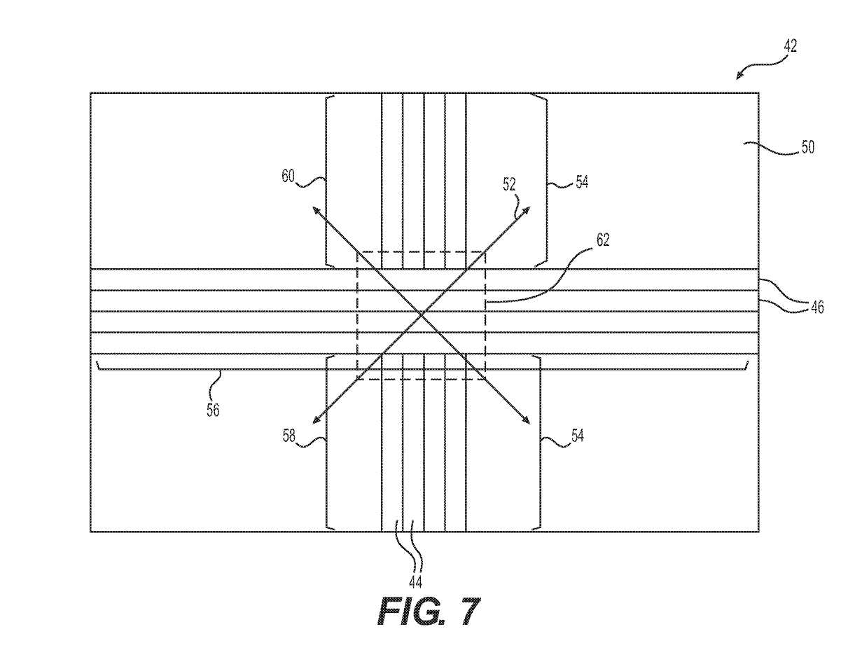

FIG. 7 is a graphical representation of a second embodiment of the present invention. This second embodiment is a variation of the first embodiment illustrated in FIG. 6. In this second embodiment, the first pad-up area 54 and the second pad-up area 56 are placed onto the laminate or curved element 50 such that the two pad-up areas 54, 56 overlap one another. In this contemplated embodiment, a thicker pad-up section is created at an intersecting area 62 where the first pad-up area 56 overlaps the second pad-up area 54. As in the embodiment illustrated in FIG. 6, in the non-intersecting area, both the tows 44 of the first pad-up area 54 and the tows 46 of the second pad-up area 56 have a fiber direction that extends along the direction of the pad-up area 54, 56 respectively.

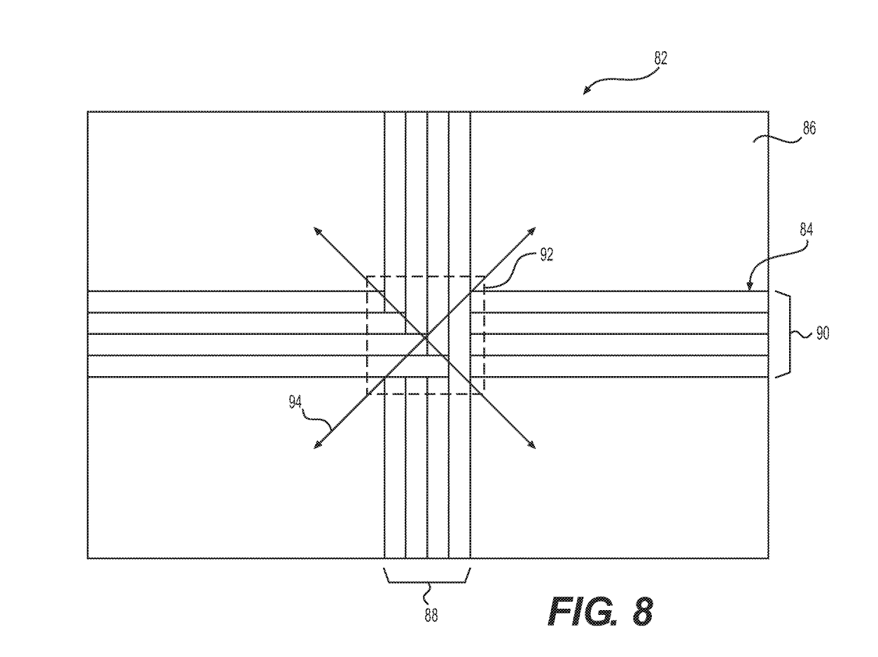

FIG. 8 is a graphical, top view of a fourth embodiment of an aircraft component 82 according to the present invention. The aircraft component 82 includes a pad-up area 84 that is disposed onto a laminate, such as a curved element 86. The pad-up area 84 includes a first plurality of tows 88 laid along a first direction of the laminate or curved element 86. The pad-up area 84 also includes a second plurality of tows 90 that are disposed along a second direction of the laminate or curved element 86. Consistent with the nomenclature provided above, the first plurality of tows 88 form a first pad-up area and the second plurality of tows 90 form a second pad-up area. Together the tows 88, 90 form a single pad-up ply.

As shown in FIG. 8, the plurality of second tows 90 do not extend, unbroken, across the width of the laminate or curved element 86. Instead, the first plurality of tows 88 and the second plurality of tows 90 are laid in a stepped, abutting pattern with respect to one another. In this third embodiment, none of the first plurality of tows 88 or the second plurality of tows 90 overlap one another, thereby avoiding any buildup of composite materials within the intersecting area 92. As before, the plurality of first tows 88 and the plurality of second tows 90 may overlap one another in a variation of the illustrated embodiment. Once again, orthogonal arrows 94 are provided to provide an orientation with the other embodiments described herein.

In the embodiments shown in FIGS. 6 through 8, the tows or the first pad-up areas and the second pad-up areas are laid such that their fiber directions extend along the lengths of the two pad-up areas. In this manner, within a single pad-up ply (that includes both a first pad-up area and a second pad-up area) there are tows that extend in different directions in relation to each other, angled with respect to one another by a predetermined angle, i.e., 30°, 45°, 60°, and/or 90°. Among others, this provides the benefit, within the same pad-up ply, of two directions of fiber strength. In addition, by laying the tows such that they extend along the lengths of the of the pad-up areas, it becomes possible to lay longer strips of tows than if the entire pad-up ply had tows laid in the same direction. The lengths of the fiber tows also adds to the strength of the pad-up areas.

In addition, the directions of the first and second pad-up areas may be selected such that at least one of the first pad-up area and the second pad-up area extends along a load-path of the component. In this manner, the fiber directions of the pad-up area extend along the load paths, thereby aligning the directions of the fibers (and therefore the fiber strength) with the load paths. In a non-limiting embodiment, both the first pad-up area and the second pad-up area extend along load paths of the component, thereby taking advantage of fiber strength in both directions within the same pad-up ply.

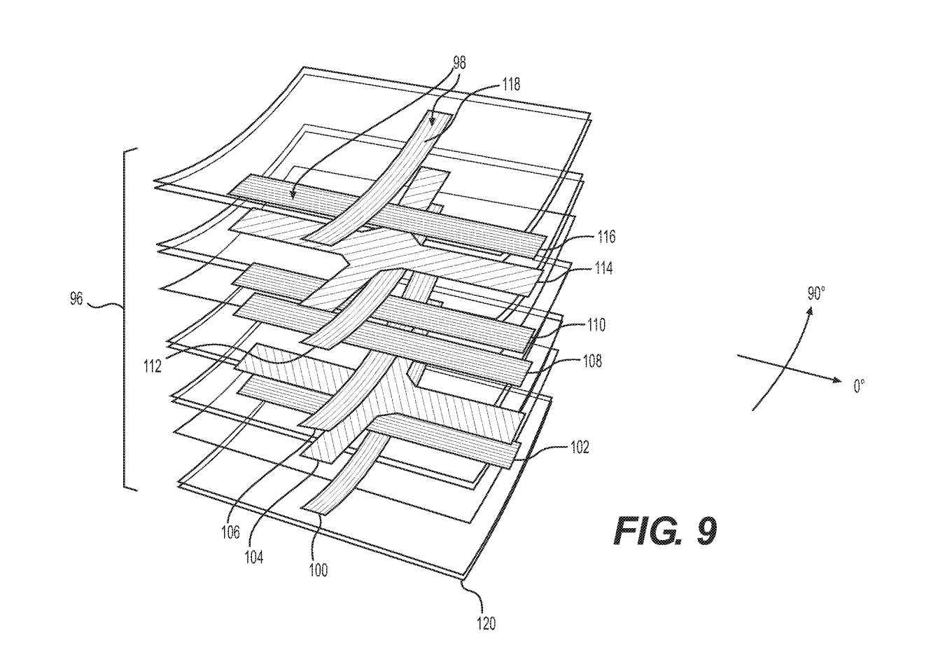

FIG. 9 is an exploded, perspective illustration of an aircraft component 96, showing one contemplated arrangement of multiple plies of prepreg materials layered on top of one another to form a pad-up area 98. In between the plies that form the pad-up area 98 are interleafed layers of composite material that also form the aircraft component 96.

In FIG. 9, ten pad-up areas 100, 102, 104, 106, 108, 110, 112, 114, 116, 118 are layered on top of the interleafed layers of the aircraft component 96 and on top of one another to form a stack. Fiber orientations for the pad-up areas 100, 102, 104, 106, 108, 110, 112, 114, 116, 118 are discussed in accordance with the legend provided on FIG. 9. The 0° orientation is parallel to the width of the curved surface 120 (i.e., the lateral direction or first fiber orientation). The 90° orientation is parallel to the longitudinal dimension of the curved surface 20 (i.e., the longitudinal direction or second fiber orientation). Several of the pad-up areas 100, 102, 104, 106, 108, 110, 112, 114, 116, 118 have different shapes and fiber orientations, the details of which are provided below.

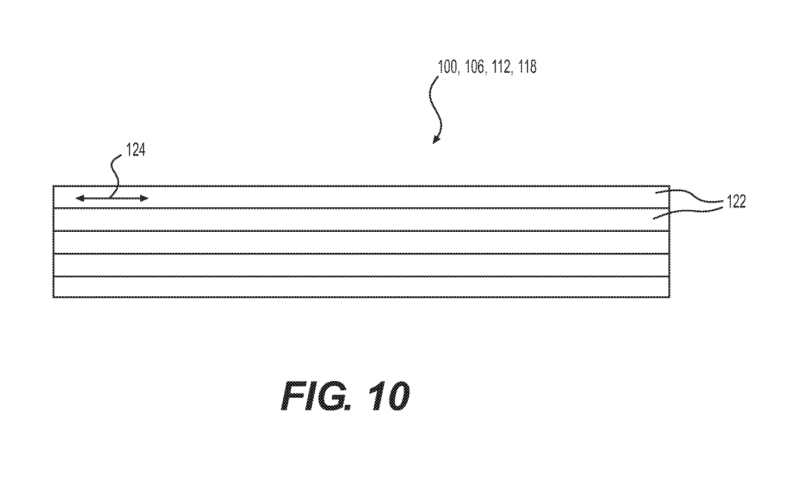

As illustrated in FIG. 10, the first pad-up area 100 is contemplated to include tows 122 that extend along a length of the pad-up area 100, which is along a longitudinal dimension of the laminate or curved surface 120. The tows 122, therefore, have a fiber orientation 124 of 90°. As discussed above, it is contemplated that the tows 122 forming the first pad-up area 100 will be laid side-by side by an AFP machine. The fourth pad-up area 106, the seventh pad-up area 112, and the tenth pad-up area 118 are contemplated to share the same construction and fiber orientation as the first pad-up area 100. It is noted that the pad-up areas 100, 106, 112, 118 may have different fiber orientations 124 without departing from the scope of the present invention.

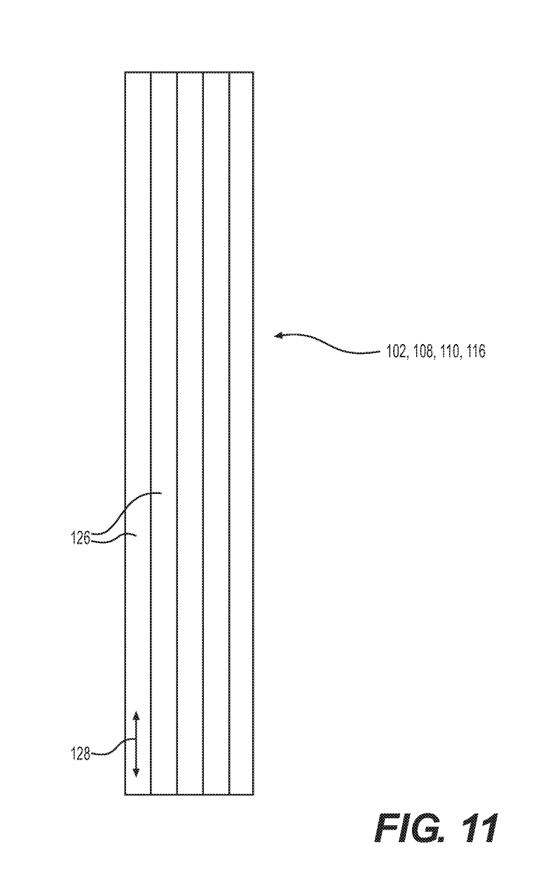

As illustrated in FIG. 11, the second pad-up area 102 is contemplated to include tows 126 that extend along the length of the pad-up area 102, which in the embodiment shown is along a lateral dimension of the laminate or curved surface 120. The tows 126, therefore, have a fiber orientation 128 of 0°. As discussed above, it is contemplated that the tows 126 forming the second pad-up area 102 will be laid side-by side by an AFP machine. The fifth pad-up area 108, the sixth pad-up area 110, and the ninth pad-up area 116 are contemplated to share the same construction and fiber orientation as the second pad-up area 102.

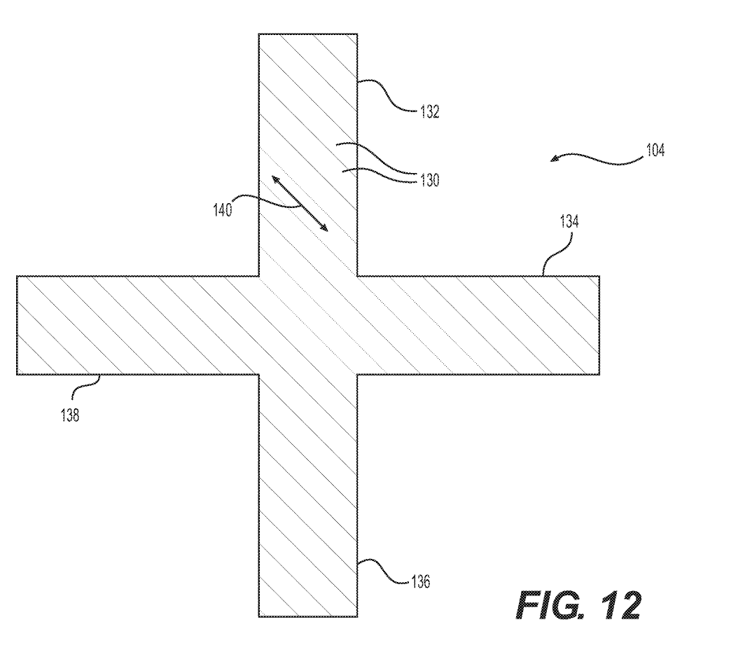

As illustrated in FIG. 12, the third pad-up area 104 is a “plus”-shaped pad-up area 104 that includes tows 130 at a −45° angle. The third pad-up area 104 defines arms 132, 134, 136, 138 that extend in both the longitudinal and the lateral directions. The tows 130 of the third pad-up area 104 are contemplated to have fiber orientations 140 that are parallel to the directions of the tows 130 and are, therefore, at a −45° angle with respect to the axes of the curved element 120 illustrated in FIG. 9.

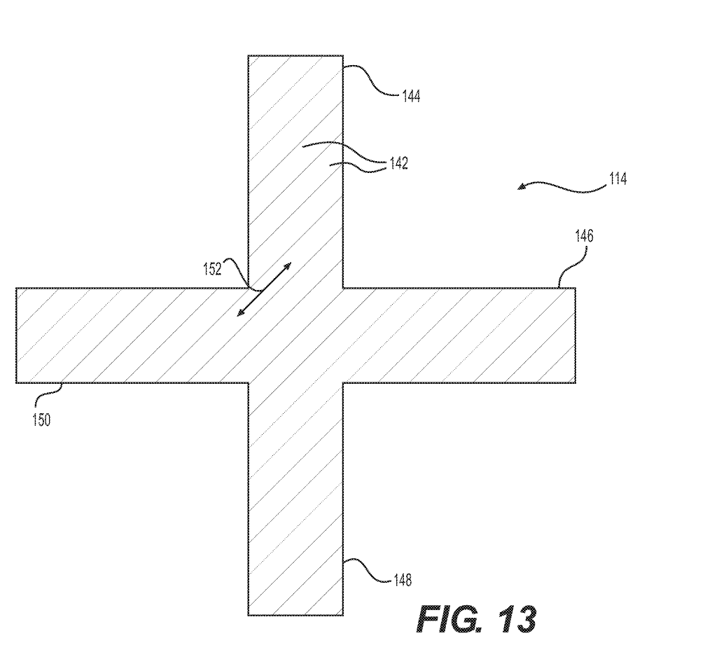

As illustrated in FIG. 13, the eighth pad-up area 114 also is a “plus”-shaped pad-up area 114 that includes tows 142 at a 45° angle. This eighth pad-up area 114 is similar to the third pad-up area 104, except that the orientation is rotated 90° with respect to the third pad-up area 104. The arms 144, 146, 148, 150 of the eighth pad-up area 114, therefore, extend in both the longitudinal and the lateral directions. The tows 142 of the eighth pad-up area 114 are contemplated to have fiber orientations 152 that are parallel to the directions of the tows 142 and are, therefore, at a 45° angle with respect to the axes of the curved element 120 illustrated in FIG. 9.

In connection with the fiber orientations 124, 128, 140, 152 discussed with respect to FIGS. 9-13, it is noted that the fiber orientations 124, 128, 140, 152 change in increments of 45° for the different pad-up areas 100, 102, 104, 106, 108, 110, 112, 114, 116, 118 in the stack. The present invention, however, is not contemplated to be limited to constructions where the fiber orientations 124, 128, 140, 152 change in increments of 45° for the different pad-up areas 100, 102, 104, 106, 108, 110, 112, 114, 116, 118 in the stack.

In one alternative embodiment, it is contemplated that the fiber orientations 124, 128, 140, 152 may be changed in increments of 30° and/or 60°. As such, it is contemplated that the fiber orientations 124, 128, 140, 152 may be set at 0°, 30°, −30°, 60°, −60°, and 90°, etc., respectively.

In a further contemplated embodiment, the fiber orientations 124, 128, 140, 152 may be altered in 15° increments without departing from the scope of the present invention.

As should be apparent from the foregoing, the angle of change for the fiber orientations 124, 128, 140, 152 between pad-up areas 100, 102, 104, 106, 108, 110, 112, 114, 116, 118 in the stack may be selected to be any particular value without departing from the scope of the present invention. It is noted, however, that increments of 30° are preferred to enhance the strength of the resulting composite structure.

In other contemplated embodiments, such as the embodiments illustrated in FIGS. 10-13, the change in fiber orientations may vary from pad-up area to pad-up area. In other words, the present invention contemplates, but does not require that the changes in fiber orientations follow any particular pattern.

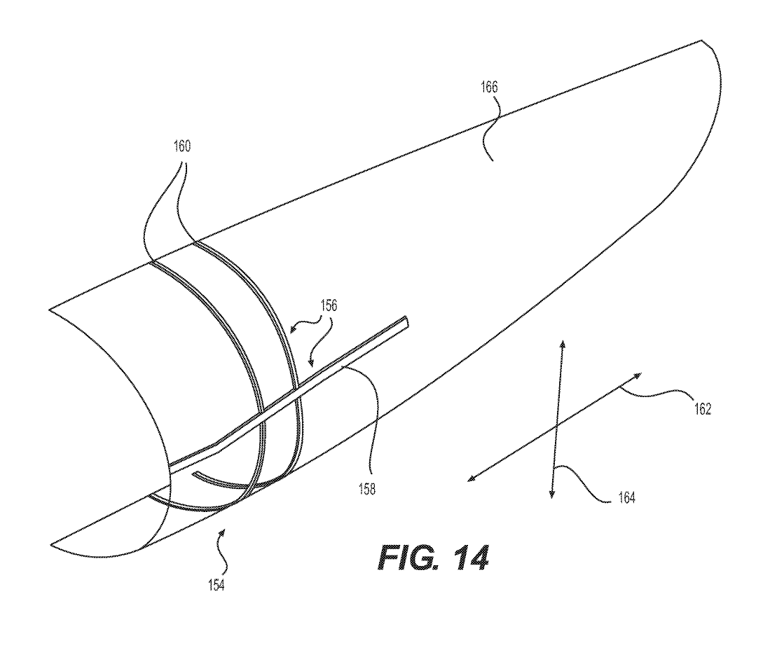

FIG. 14 is a perspective illustration of an aircraft component 154 manufactured according to the present invention. The aircraft component 154 may be a portion of the fuselage of the jet aircraft 10. In particular, the aircraft component 154 may be a part of the tail section 12 of the jet aircraft 10.

The aircraft component 154 is contemplated to include a plurality of pad-up areas 156. For simplicity, the pad-up areas 156 include first pad-up areas 158 and second pad-up areas 160. The first pad-up areas 158 are contemplated to extend along the longitudinal direction 162 (i.e., a first fiber orientation). The second pad-up areas are contemplated to extend along the lateral direction 164 of the aircraft component 154 (i.e., a second fiber orientation). The pad-up areas 158, 160 are contemplated to comprise a plurality of tows that are laid onto the laminate or curved surface 166 in one or more of the manners described hereinabove.

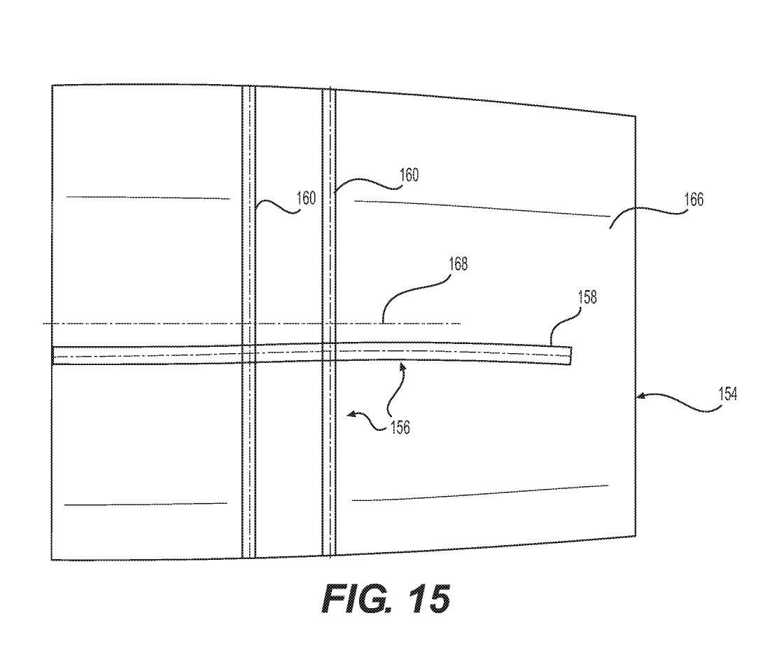

FIG. 15 is a view of the aircraft component 154 illustrated in FIG. 14. In this view, the longitudinal axis 168 of the aircraft component 154 is included as a reference tool. It is noted that the first pad-up area 158 is illustrated as being substantially parallel to the longitudinal axis 168. Accordingly, the second pad-up areas 160 are shown as being orthogonal to the first pad-up areas 158. It is noted that the illustration of the first pad-up areas 158 as being disposed along the longitudinal axis and the orientation of the second pad-up areas as being orthogonal to the first pad-up areas 158 is merely illustrative. The pad-up areas 158, 160 may have any orientation with respect to the longitudinal axis 168 without departing from the scope of the present invention.

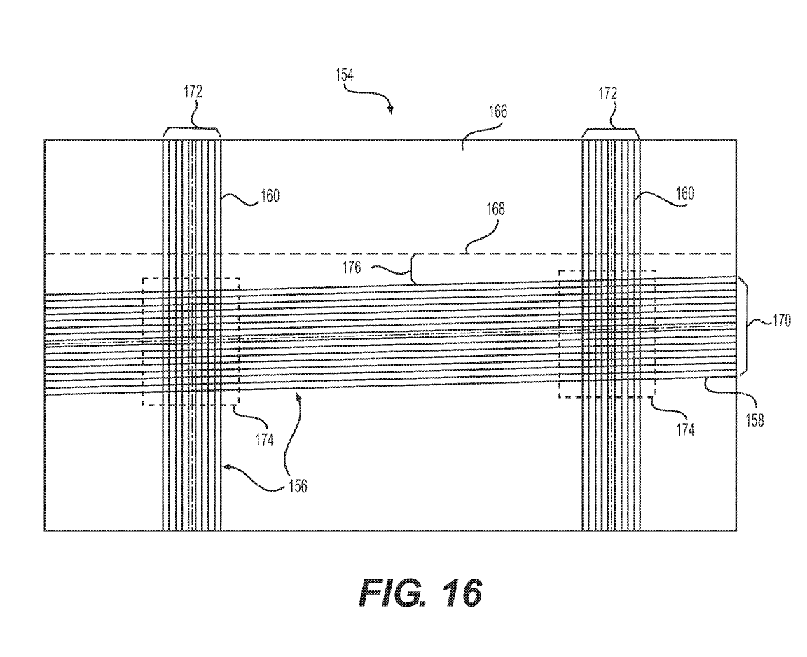

FIG. 16 provides an enlarged detail of a portion of the aircraft component 154 that is illustrated in FIGS. 14 and 15. The first pad-up areas 158 are laid as a plurality of first tows 170 by an AFP machine. The second pad-up areas 160 also are laid as a plurality of second tows 172 by an AFP machine. The tows 170, 172 cross each other at intersecting areas 174, which may or may not include overlapping tows 170, 172. The first plurality of tows 170 are disposed at an angle 176 from the longitudinal axis 168.

With continued reference to FIG. 16, it is noted that the first plurality of tows 170 are disposed at the angle 176 because the aircraft component 154 has a curved shaped in three dimensions. This deviation angle 176 should be understood by those skilled in the art as being a direction in which the tows 170 are “steered” to form the first pad-up area 158.

For purposes of the present invention, “steering” refers to the ability of the AFP machine to direct the tows 170 in a direction that deviates, by the deviation angle 176, from the reference axis, in this case the longitudinal axis 168. Steering permits the AFP machine to establish changes in the direction of the first pad-up area 158 to accommodate changes in the curvature of the surface of the aircraft component 154.

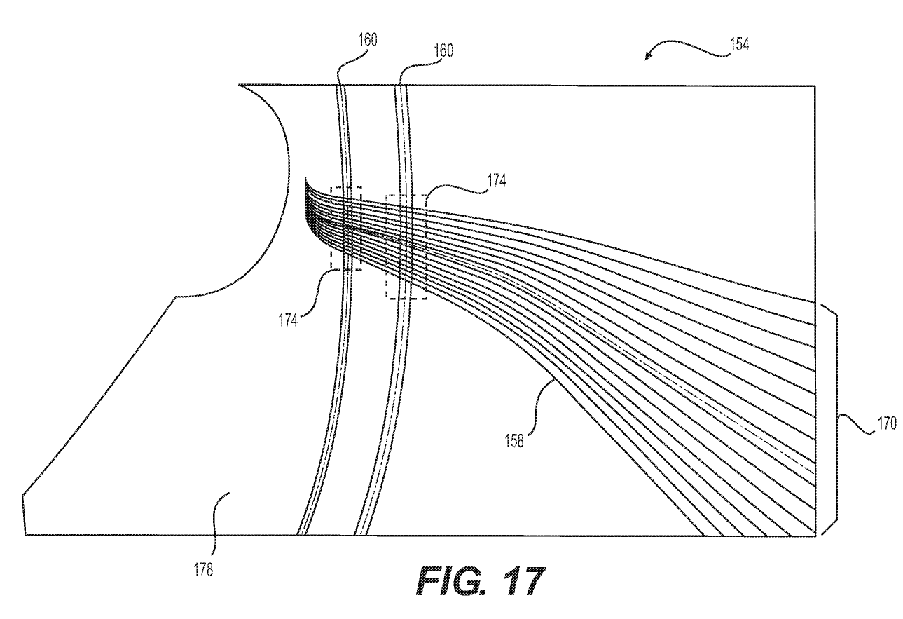

FIG. 17 is a perspective illustration of the interior surface 178 of the aircraft component 154 illustrated in FIGS. 14-16. The first plurality of tows 170 are illustrated as being steered across the interior surface 178, in the manner discussed above.

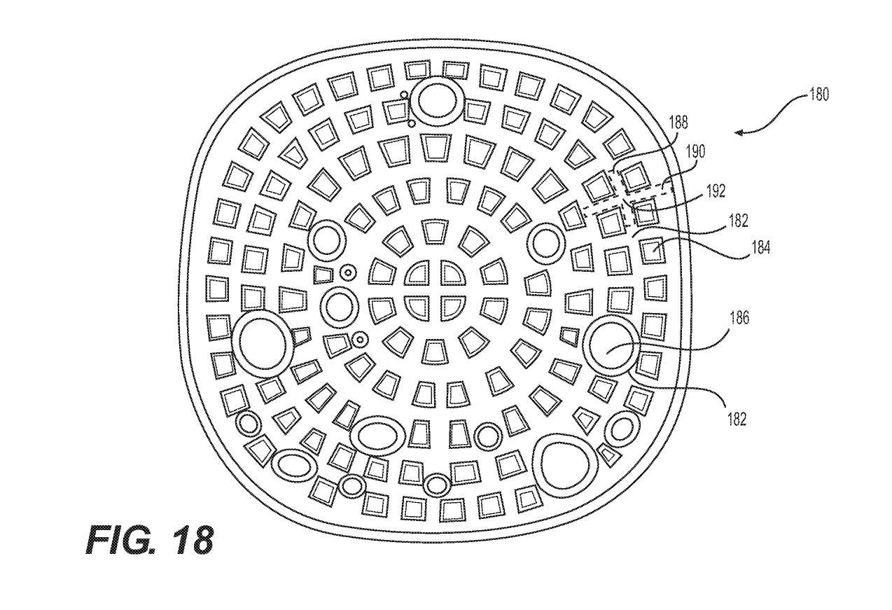

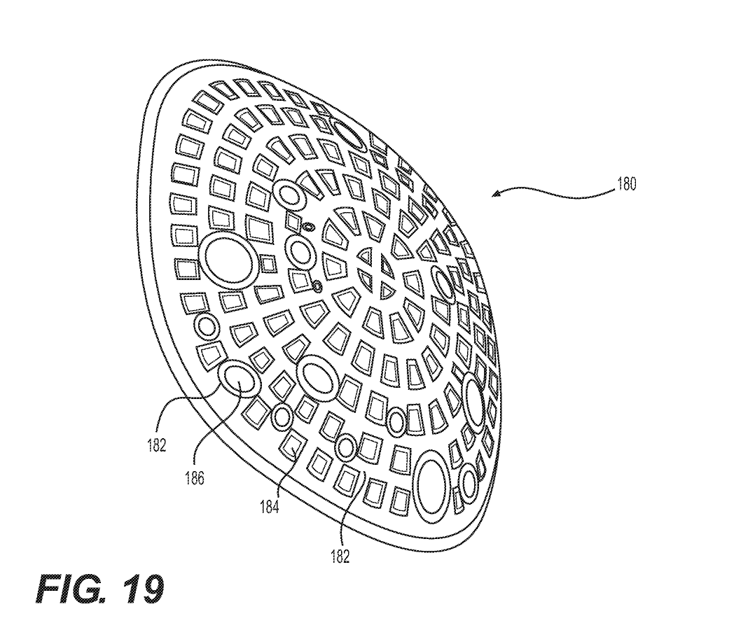

FIG. 18 is a top view of another embodiment of an aircraft structure 180 according to the present invention. FIG. 19 is a perspective view of the aircraft structure 180 illustrated in FIG. 18. As made apparent from the illustrations in FIGS. 18 and 19, the aircraft structure 180 has a curved structure and appears somewhat like a turtle shell. The aircraft structure 180 is referred to as a “pressure shell,” because it assists with maintaining suitable cabin pressure when the jet aircraft 10 is in a flight mode of operation. The aircraft structure 180 is contemplated to include pad-ups 182, interstitial areas 184, and openings 186 therethrough.

To construct the aircraft structure 180, it is contemplated that the lattice pattern of pad-up areas comprise first pad-up areas 188 (a portion of which are delineated in FIG. 18) and second pad-up areas 190 (a portion of which are delineated in FIG. 18) that may be applied to a component in a tortoise shell manner, such that the first pad-up areas 188 are provided as substantially concentric wheels and the second pad-up areas 190 are provided as spokes that intersect the wheels. After a sufficient number of tows are layered on top of one another, the final structure of the aircraft structure 180 is produced.

Consistent with other embodiments, constructing the aircraft structure 180 with first pad-up areas 188 and second pad-up areas 190 that intersect at intersecting areas 192 results in an aircraft component 180 with suitable strength in the load bearing directions of the structure. It is noted that the aircraft component includes interstitial areas 184 that are between the pad-up areas 188, 190, as illustrated in other embodiments. As a pressure shell, the aircraft component 180 is provided with beneficial strength properties in the directions of the pad-up areas 188, 190.

As for the prepreg composite material from which the tows are made, as noted above, it is contemplated that the individual tows have a width of about 0.25 inches (or 0.64 cm). While this dimension is contemplated to be applied to all of the embodiments described herein, the present invention should not be understood to be limited to tows with this width. For the present invention, the tows may have widths of 0.5 in. (1.27 cm), 0.75 in. (1.91 cm), 1 in. (2.54 cm), 2 in. (5.08 cm), for example. The present invention is not contemplated to be limited to tows with any particular width or other physical characteristics.

As noted above, the present invention is contemplated to employ carbon fiber materials that are pre-impregnated with resin. However, the present invention should not be understood to be limited to this material. To the contrary, the present invention is contemplated to find applicability to any number of different composite materials.

In addition, while the present invention contemplated that an AFP machine will be employed to create the pad-up areas 100, 102, 104, 106, 108, 110, 112, 114, 116, 118 discussed in connection with FIGS. 9-13, the present invention is not intended to be limited thereto. Other types of machines may be employed to build-up the pad-up areas 100, 102, 104, 106, 108, 110, 112, 114, 116, 118 without departing from the scope of the present invention.

Concerning the fiber orientations 124, 128, 140, 152, it is contemplated that they will be oriented with respect to a 0° direction established by the laminate. In other words, the fiber orientations 124, 128, 140, 152 of the pad-up areas 100, 102, 104, 106, 108, 110, 112, 114, 116, 118 will be set according to the primary orientation established by the laminate. While not critical to operation of the present invention, it is contemplated that the 0° orientation will be consistent with the longitudinal axis of the aircraft.

As noted above, and as should be apparent from the discussion of steered tows in connection with FIGS. 16-17, any discussion of the “longitudinal” or “lateral” direction should not be understood as limiting the present invention to orientations that are parallel to the longitudinal axis of the jet aircraft 10 or any other axes orthogonal thereto. The terms “longitudinal” and “lateral” have been used herein to facilitate, but not limit, the description of the present invention.

With respect to the present invention, as noted above, the fiber orientations are contemplated to extend in directions that are parallel (or substantially parallel) to the lengths of the associated tows. With this fiber orientation, the tows are laid, for the most part, in directions that are parallel to the travel directions of the pad-up areas created therewith, and as such, extending along the lengths of the respective pad-up areas. As a result, it is contemplated that the pad-ups will provide sufficient strength to perform as required or as desired.

As should be apparent from the foregoing, by employing tows to create the pad-up areas, it becomes possible to control strictly the final weight of the aircraft component created thereby. As may be apparent, each tow adds a very small amount of weight to the aircraft component but greatly strengthens that same aircraft component. By laying the tows in a layer by layer fashion, it becomes possible to create an aircraft component with considerable strength properties but also with reduced weight by comparison with an equivalent aircraft component made from aluminum or an aluminum alloy. This weight savings contributes to an overall weight savings for the jet aircraft 10 as a whole.

In addition, given that each pad-up ply includes first pad-up areas and second pad-up areas that have respective different fiber directions, less plies can be used to build the pad-ups than in the case where a single pad-up ply includes fibers in only a single fiber direction. It is contemplated that fewer plies includes, but is not limited to, embodiments where there is less material used, less fiber material used, and/or fewer tows, among others More specifically, the pad-up plies according to the present invention provide similar fiber strength properties to what previously required two separate pad-up plies. Therefore, less plies can be used, thereby saving weight.

In addition, by laying the tows along the directions of their respective pad-up areas, it is contemplated that the AFP machine itself will benefit from enhanced efficiencies. As may be apparent to those skilled in the art, AFP machines are well-suited to lay tows in a line, whether steered or not. As such, there is an increased efficiency in instances where the tows may be laid in long strips rather than in short segments. The greater the distance traversed by the AFP machine in a single direction, the greater the operational efficiency of the AFP machine.

In connection with the positioning of the first and second pad-up areas described above, it is noted that the second pad-up areas are described as being orthogonally disposed, or substantially orthogonally disposed with respect to the first pad-up areas. The orthogonal orientation of the first and second pad-up areas is contemplated to establish a lattice pattern that enhances the strength properties of the aircraft component on which the first and second pad-up areas are disposed. As should be apparent to those skilled in the art, the overall strength properties of the aircraft component are further enhanced by the attachment of the structural elements to the pad-up areas.

It is noted that the first and second pad-up areas are contemplated to be disposed along a load path of the aircraft component. More specifically, first load paths of the aircraft component are contemplated to lie along a longitudinal axis of the aircraft component, which may or may not align with the longitudinal axis of the jet aircraft 10. Second load paths of the aircraft component are contemplated to extend orthogonally to the first load paths. In the preceding discussion, this may be consistent with a lateral axis or a circumferential direction associated with the aircraft component.

It is noted that the first and second load paths are not intended to be limiting of the present invention. There are instances, particularly in the construction of the wings and control elements of the jet aircraft 10 where first and second load paths merge and/or are indistinguishable from one another. The present invention is intended to encompass the greatest breadth and, therefore, is not limited to the exemplary orientations of the first and second load paths discussed herein.

As noted above, the first and second pad-up areas intersect with one another, either in an overlapping or a non-overlapping manner, to form a lattice structure, which enhances the strength properties of the aircraft component. As discussed above, the first and second pad-up areas may intersect one another at an intersection area. The first and second pad-up areas my overlap or may not overlap one another. Regardless of whether or not the first and second pad-up areas overlap one another, the first and second pad-up areas are contemplated to for a single pad-up ply, as discussed. Multiple pad-up plies are stacked on top of one another, as illustrated in FIG. 9. The difference plies are contemplated to include tows at varying angular displacements, as discussed in connection at least with FIG. 9.

As noted above, the embodiment(s) described herein are intended to be exemplary of the wide breadth of the present invention. Variations and equivalents of the described embodiment(s) are intended to be encompassed by the present invention, as if described herein.

What is claimed is:

1. A composite component for a vehicle, comprising:
a laminate made from a composite material;
a first pad-up area applied to the laminate, wherein the first pad-up area comprises a plurality of first tows laid next to one another in a side-by-side arrangement and wherein the first pad-up area defines a first fiber orientation; and
a second pad-up area, wherein the second pad-up area comprises a plurality of second tows laid next to one another in a side-by-side arrangement and wherein the second pad-up area defines a second fiber orientation that differs by a predetermined angle from the first fiber orientation,
wherein the first pad-up area and the second pad-up area intersect at an intersecting area and together form a first pad-up ply on the laminate.

2. The composite component of claim 1, wherein the first fiber orientation is along a first load path of the composite component.

3. The composite component of claim 2, wherein the second fiber orientation is along a second load path of the composite component.

4. The composite component of claim 1, wherein at least a portion of the first pad-up area and the second pad-up area lie in the same layer.

5. The composite component of claim 1, wherein at least one interleaf layer is positioned between the first pad-up area and the second pad-up area.

6. The composite component of claim 1, wherein the first pad-up area and the second pad-up area overlap at the intersecting area.

7. The composite component of claim 1, wherein the first pad-up area abuts the second pad-up area at the intersecting area.

8. The composite component of claim 1, wherein the predetermined angle is less than or equal to about 90°.

9. The composite component of claim 1, wherein the first pad-up ply is applied to the laminate via an automated fiber placement machine.

10. The composite fiber component of claim 1, wherein the first pad-up area is applied to the laminate via an automated fiber placement machine by steering the plurality of first tows.

11. The composite fiber component of claim 1, wherein the second pad-up area is applied to the laminate via an automated fiber placement machine by steering the plurality of second tows.

12. The composite component of claim 9, wherein the automated fiber placement machine lays a plurality of first pad-up areas on the component prior to changing direction for laying a plurality of second pad-up areas on the component.

13. The composite component of claim 1, wherein a plurality of first pad-up areas and a plurality of second pad-up areas on the component provide a lattice of pad-up areas.

14. The composite component of claim 1, wherein the laminate, the first pad-up area, and the second pad-up area comprise carbon fiber materials preimpregnated with resin.

15. A composite component for a vehicle, comprising:
a lattice pattern of pad-up areas; and
interstitial areas positioned between the pad-up areas;
wherein the lattice pattern of pad-up areas comprises at least a first pad-up area and at least a second pad-up area that intersects with the first pad-up area,
wherein the first pad-up area has a first fiber direction that extends along a first length of the first pad-up area and the second pad-up area has a second fiber direction that extends along a second length of the second pad-up area, and
wherein the first pad-up area and the second pad-up area intersect at a predetermined angle.

16. The composite component of claim 15, wherein the first pad-up area and the second pad-up area overlap at an intersecting area.

17. The composite component of claim 15, wherein the first pad-up area abuts the second pad-up area at an intersecting area.

18. The composite component of claim 15, wherein at least one interleaf layer is positioned between the first pad-up area and the second pad-up area.

19. The composite component of claim 15, wherein at least a portion of the first pad-up area and the second pad-up area lie in the same layer.
